(19) United States
(12) Patent Application Publication
(10) Pub. No.: US 2020/0328042 A1
(43) Pub. Date: Oct. 15, 2020

(54) KEYCAP, KEYSWITCH MODULE WITH THE KEYCAP, AND JIG FOR DISPOSING THE KEYCAP

(71) Applicant: Changshu Sunrex Technology Co., Ltd., Jiangsu Province (CN)

(72) Inventors: Chun Fu TSENG, Changshu (CN); Cong XIA, Changshu (CN)

(21) Appl. No.: 16/384,836

(22) Filed: Apr. 15, 2019

(51) Int. Cl. H01H 13/14

(52) U.S. Cl. CPC H01H 13/14; H01H 13/83

(57) ABSTRACT

A keyswitch module includes base plate, supporting mechanism movably disposed on the base plate in an up-and-down direction, and a keycap disposed on and movable with the supporting mechanism. The keycap includes a keycap body, a plurality of connecting features and at least one retaining feature. The keycap body has a top wall and a surrounding wall which extends downwardly from a periphery of the top wall. The connecting features are retainingly connected with the supporting mechanism. The retaining feature is adapted to be retainingly connected with a jig for a legend forming process.

### FIELD

The disclosure relates to a keycap of a keyswitch module, and more particularly to a keycap having a retaining feature for being retainingly disposed on a jig for a legend forming process.

### BACKGROUND

A conventional keycap of a keyswitch module is manufactured by a printing technique to add a symbol or a character thereto, such as a spray printing and laser engraving. For the process of forming the symbol or character on the surface of the keycap, the conventional technique involves printing or spraying one or multiple layers of ink on the outer surface of the keycap to make the outer surface opaque, and then forming the symbol or character by laser engraving the ink layers. A jig is required to position a keycap to perform such a legend forming process.

### SUMMARY

Therefore, an object of the disclosure is to provide a keycap, a keyswitch module with the keycap, and a jig for disposing the keycap that can improve the problem of the prior art.

According to an aspect of the disclosure, the keycap includes a keycap body, a plurality of connecting features and at least one retaining feature. The keycap body has a top wall and a surrounding wall extending downwardly from a periphery of the top wall. The connecting features are formed on a lower surface of the top wall of the keycap body and are adapted to be retainingly connected with a supporting mechanism of a keyswitch module. The retaining feature is formed on the lower surface of the top wall, is spaced apart from the connecting features, and is adapted to be retainingly connected with a jig for performing a legend forming process.

According to another aspect of the disclosure, the keyswitch module includes a base plate, a supporting mechanism movably disposed on the base plate in an up-and-down direction, and a keycap disposed on and movable with the supporting mechanism. The keycap includes a keycap body, a plurality of connecting features and at least one retaining feature. The keycap body has a top wall and a surrounding wall which extends downwardly from a periphery of the top wall. The connecting features are formed on a lower surface of the top wall of the keycap body and are retainingly connected with the supporting mechanism. The retaining feature is formed on the lower surface of the top wall and is spaced apart from the connecting features. The retaining feature is adapted to be retainingly connected with a jig for a legend forming process.

According to still another aspect of the disclosure, the jig for positioning the above-mentioned keycap to perform a legend forming process includes a jig body and a positioning block formed on the jig body. The positioning block has a mounting wall which faces and abuts against the lower surface of the top wall of the keycap body, at least one positioning feature which is formed on the mounting wall and engaged with the retaining feature, and a plurality of recesses which are formed in the mounting wall for receiving the connecting features, respectively.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of a keyswitch module according to the disclosure;

FIG. 2 is a partly exploded perspective view of the first embodiment;

FIG. 3 is an exploded perspective view of the first embodiment;

FIG. 4 is a schematic side view illustrating a state when a keycap of the keyswitch module is not pressed;

FIG. 5 is a schematic side view illustrating a state when the keycap is pressed;

FIG. 6 is a perspective view of a keycap of the first embodiment disposed on a jig;

FIG. 7 is an exploded perspective view of FIG. 6;

FIG. 8 is a perspective view illustrating a second embodiment of the keyswitch module according to the disclosure;

FIG. 9 is a partly exploded perspective view of the second embodiment; and

FIG. 10 is an exploded perspective view of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

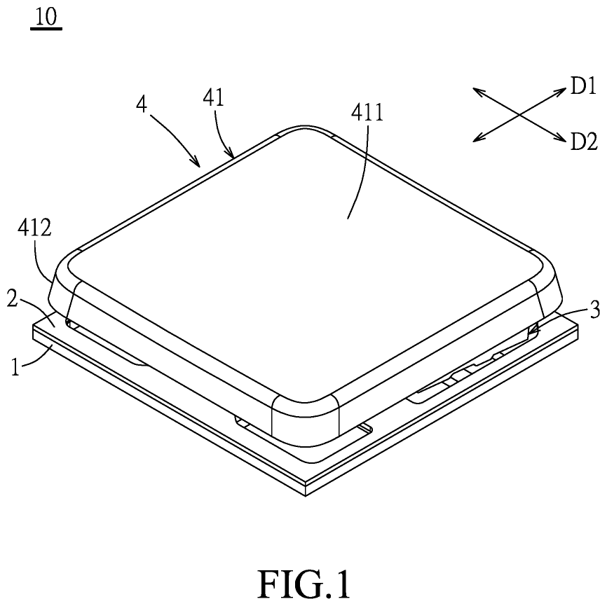

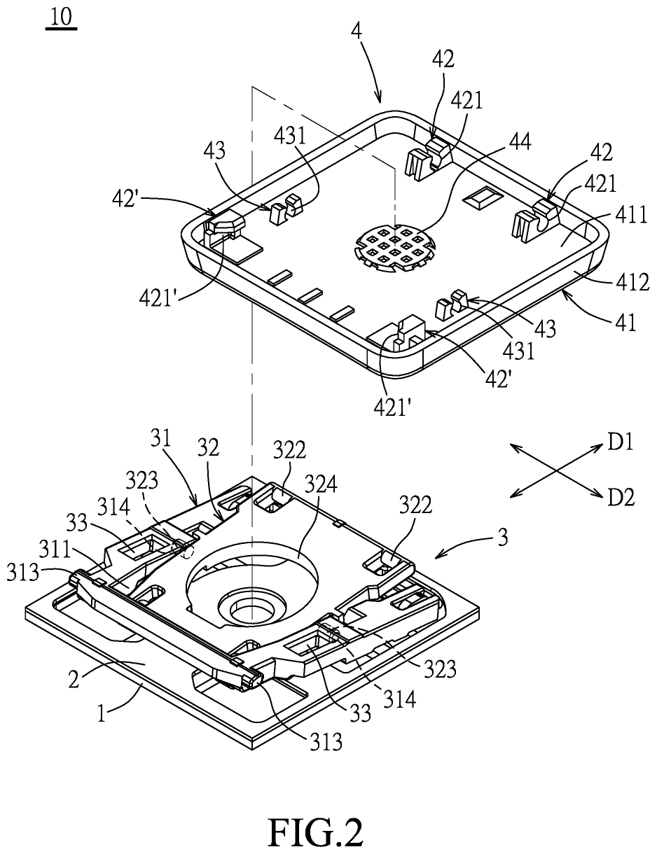

Referring to FIGS. 1 to 3, a first embodiment of a keyswitch module 10 according to the disclosure includes a base plate 1, a film circuit board 2, a supporting mechanism 3 and a keycap 4. For example, the first embodiment is applied to a keyboard (not shown) which has a plurality of keyswitch modules 10.

The base plate 1 is a square plate in this embodiment, and is made of a plastic material. The base plate I has a plate body 11 defining a plane which extends in both a lengthwise direction (DI) and a widthwise direction (D2) that is transverse to the lengthwise direction (D1), two first hooks 12 extending upwardly from the plate body 11, spaced apart from each other in the widthwise direction (D2) and adjacent to a side of the plate body 11, two second hooks 13 extending upwardly from the plate body 11, spaced apart from each other in the widthwise direction (D2) and adjacent to an opposite side of the plate body 11 in the lengthwise direction (D1), and two stop portions 14 extending upwardly from the plate body 11, spaced apart from each other in the widthwise direction (D2) and adjacent to the first hooks 12. Each of the first hooks 12 has a hook end facing in the lengthwise direction (D1) and away from that of each of the second hooks 13. The film circuit board 2 is attached to the base plate 1.

The supporting mechanism 3 is movably disposed on the base plate 1 in an up-and-down direction. The supporting mechanism 3 includes a first supporting member 31 and a second supporting member 32 pivotably connected to each other about a central axis in a first direction, i.e., the widthwise direction (D2). Specifically, the first and second supporting members 31, 32 may be made of a plastic material. The width of the first supporting member 31 in the widthwise direction (D2) is larger than that of the second supporting member 32. The first supporting member 31 is formed with an accommodation slot 311 extending therethrough in the up-and-down direction such that the second supporting member 32 is received in the accommodation slot 311. More specifically, the first supporting member 31 has two central pivot grooves 314 disposed at a center thereof and communicated with the accommodation slot 311, two first ends 310 opposite to each other in a second direction, i.e., the lengthwise direction (D1), and two recesses 33 for receiving the retaining features 43, respectively. Two pin-shaped first pivot portions 312 are disposed at one first end 310 and each extend in the widthwise direction (D2) to be engaged with the first hooks 12, respectively. Two pin-shaped second pivot portions 313 are disposed at the other first end 310 and each extend in the widthwise direction (D2) . The first supporting member 31 abuts against the stop portions 14 to prevent excess rotation thereof. The second supporting member 32 has two central pivot pins 323 disposed at a center thereof and respectively and rotatably engaged in the central pivot grooves 314 to permit rotation of the second supporting member 32 relative to the first supporting member 31 about the central axis, and two second ends 320 opposite to each other in the second direction. Two pin-shaped third pivot portions 321 are disposed at one second end 320 and each extend in the widthwise direction (D2) to be engaged with the second hooks 13, respectively. Two pin-shaped fourth pivot portions 322 are disposed at the other second end 320 and each extend in the widthwise direction (D2). Thus, the first and second supporting members 31, 32 are formed as a scissor-shaped supporting structure.

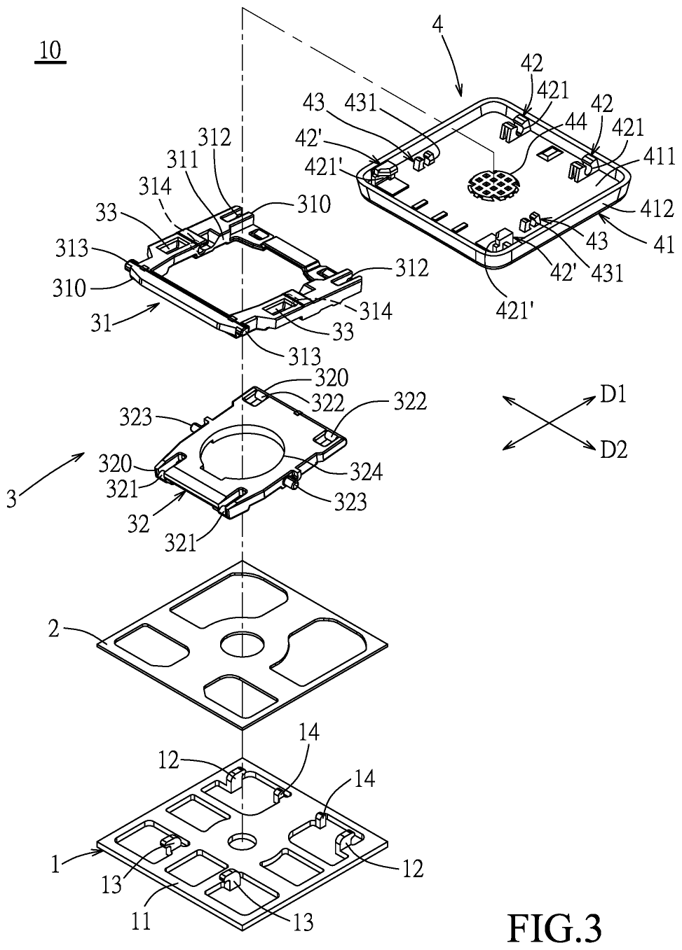

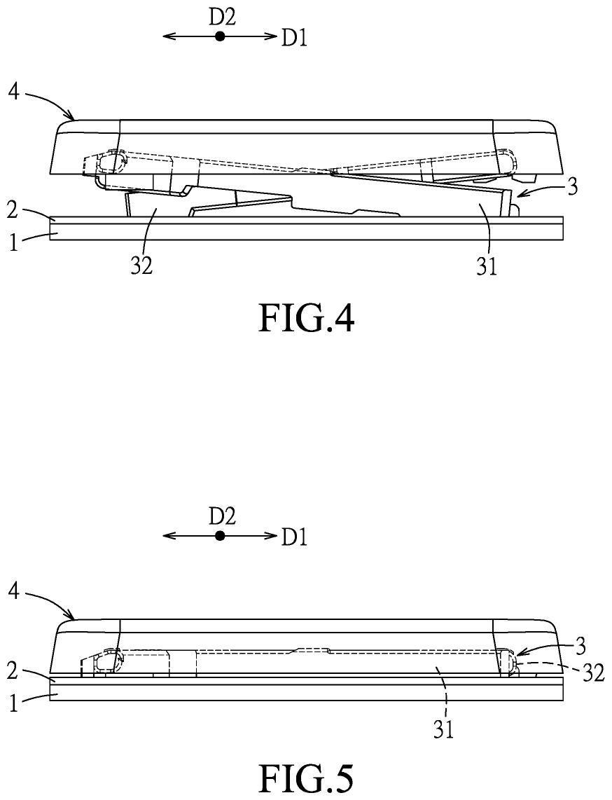

Referring to FIGS. 3 to 5, the keycap 4 is disposed on and movable with the supporting mechanism 3 relative to the base plate 1 in the up-and-down direction. The keycap 4 includes a keycap body 41, four connecting features 42, 42′ and two retaining features 43. The keycap 4 may be made of a plastic material. The number of the connecting features 42, 42′ and the retaining features 43 may be varied. The keycap body 41 has a top wall 411 and a surrounding wall 412 extending downwardly from a periphery of the top wall 411. The connecting features 42, 42′ are formed on a lower surface of the top wall 411 of the keycap body 41 and are retainingly connected with the supporting mechanism 3. In this embodiment, two of the connecting features 42 each are formed with a connecting groove 421 engaged with the respective fourth pivot portion 322 of the second supporting member 32 to permit rotation of the connecting features 42 relative to the second supporting member 32. The other two connecting features 42′ each are formed with a connecting groove 421′ engaged with the respective second pivot portion 313 of the first supporting member 31 to permit rotation of the connecting features 42′ relative to the first supporting member 31. Moreover, the connecting features 42, 42′ are disposed in proximity of the periphery of the top wall 411 of the keycap body 41 so as to render the keycap 4 stable upon mounting on the supporting mechanism 3. More specifically, during the up-and-down movement of the keycap 4 relative to the base plate 1, the second pivot portions 313 slide relative to the connecting grooves 421′ of the corresponding connecting features 42′, and the third pivot portions 321 slide relative to the corresponding second hooks 13 of the base plate 1. The keycap 4 further includes a circular press protrusion 44 formed on a center of the lower surface of the top wall 411 of the keycap body 41. The keyswitch module 10 further includes a biasing member (not shown) disposed between the press protrusion 44 and the film circuit board 2. The second supporting member 32 is further formed with a through bore 324 for the biasing member passing therethrough.

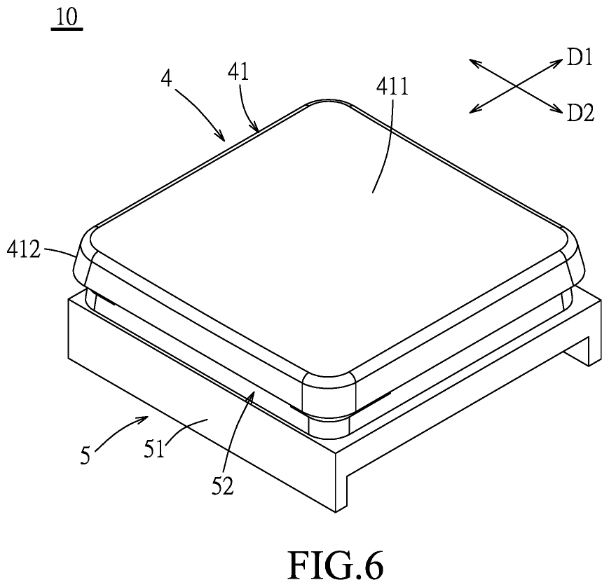

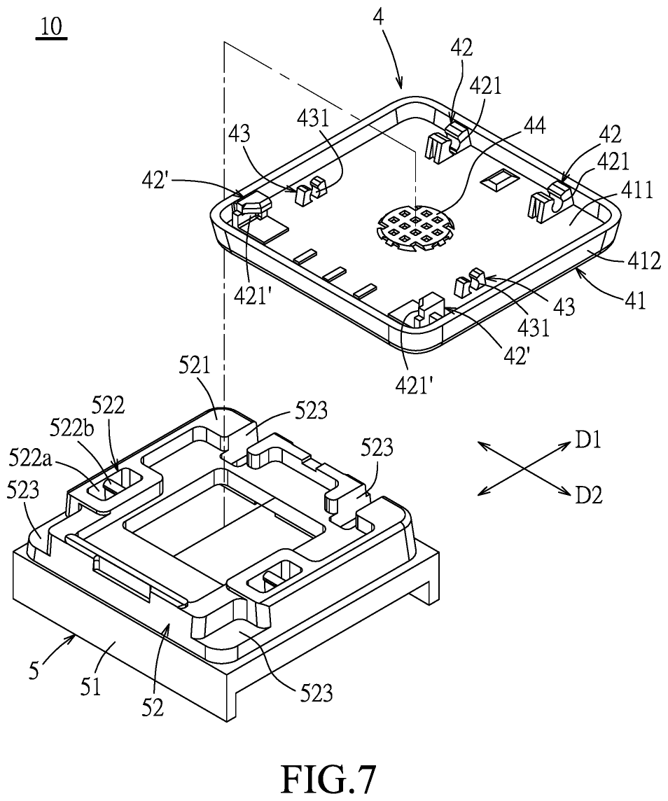

Referring to FIGS. 1, 3, 6 and 7, the retaining features 43 are formed on and extend downwardly from the lower surface of the top wall 411 of the keycap body 41 and are spaced apart from the connecting features 42, 42′. The retaining features 43 are adapted to be retainingly connected with a jig 5 for performing a legend forming process, such as a laser engraving or spray painting process. With the retaining features 43 rather than the connecting features 42, 42′ positioned on the jig 5, damage to the connecting features 42, 42′ during assembling with and disassembling from the jig 5 can be prevented so as to minimize the risk of undesired detachment of the keycap 4 of the keyswitch module 10 from the supporting mechanism 3. Moreover, the retaining features 43 are spaced apart from the connecting features 42, 42′, and are not interfered with the connecting features 42, 42′ during the assembling and disassembling with the jig 5. Further, a molding device may be designed to have an angle pin which is for forming the retaining features 43 and which can be provided independently from that for forming the connecting features 42, 42′ so as to render the molding process of the keycap 4 convenient and smooth. The retaining features 43 are spaced apart from each other along the widthwise direction (D2), and each are distant from a center of the top wall 411 of the keycap body 41 by a distance that is smaller than a distance by which each of the connecting features 42, 42′ is distant from the center of the top wall 411. Specifically, each retaining feature 43 is disposed closer to the center of the top wall 411 in the lengthwise direction (D1) than each connecting feature 42, 42′ is. Additionally, a center of each retaining feature 43 is disposed closer to the center of the top wall 411 than each connecting feature 42, 42′ is. The jig 5 includes a jig body 51 and a positioning block 52 formed on the jig body 51. The jig 5 may alternatively include a plurality of the positioning blocks 52 for positioning a plurality of the keycaps 4. The positioning block 52 has a mounting wall 521 which faces and abuts against the lower surface of the top wall 411 of the keycap body 41 of the keycap 4, two positioning features 522 which are formed on the mounting wall 521 and respectively engaged with the retaining features 43, and a plurality of recesses 523 which are formed in the mounting wall 521 for receiving the connecting features 42, 42′, respectively. Specifically, the positioning features 522 are spaced apart from each other in the widthwise direction (D2) to respectively correspond with the retaining features 43. Each positioning feature 522 is distant from a center of the mounting wall 521 in the lengthwise direction (D1) by a distance that is smaller than a distance by which each recess 523 is distant from the center of the mounting wall 521 in the lengthwise direction (D1). The recesses 523 are formed in proximity of a periphery of the mounting wall 521 of the positioning block 52 to respectively correspond with the connecting features 42, 42′. In this embodiment, each retaining feature 43 has a retaining groove 431. Each positioning feature 522 has a concavity 522a formed in the mounting wall 521 for receiving the respective retaining feature 43, and a positioning block 522b formed in the concavity 522a and engaged with the retaining groove 431 of the retaining feature 43. With the retaining features 43 closer to the center of the top wall 411 of the keycap body 41 than the connecting features 42, 42′, the keycap 4 can be stably positioned to the jig 5 for preventing undesired detachment from the jig 5 during the spray painting process and hence avoiding unintended painting inside the keycap 4. With the connecting features 42, 42′ preferably disposed in proximity of the periphery of the keycap body 41, the retaining features 43 are preferably disposed closer to the center of the keycap body 41 so as to prevent undesired tilting when positioned to the jig 5. In this embodiment, the retaining features 43 are arranged and spaced apart from each other in the widthwise direction (D2) so as to have a greater retaining effect at the ends in the widthwise direction (D2). The retaining features 43 may also be arranged and spaced apart from each other in the lengthwise direction (D1) to have a greater retaining effect at the ends in the lengthwise direction (D1), and are disposed in proximity of the center of the top wall 411 of the keycap body 41 to be stably positioned to the jig 5 for avoiding undesired detachment from the jig 5 during the legend forming process.

In a modified form, the first direction and the second direction of the previous embodiment maybe the lengthwise direction (D1) and the widthwise direction (D2), respectively.

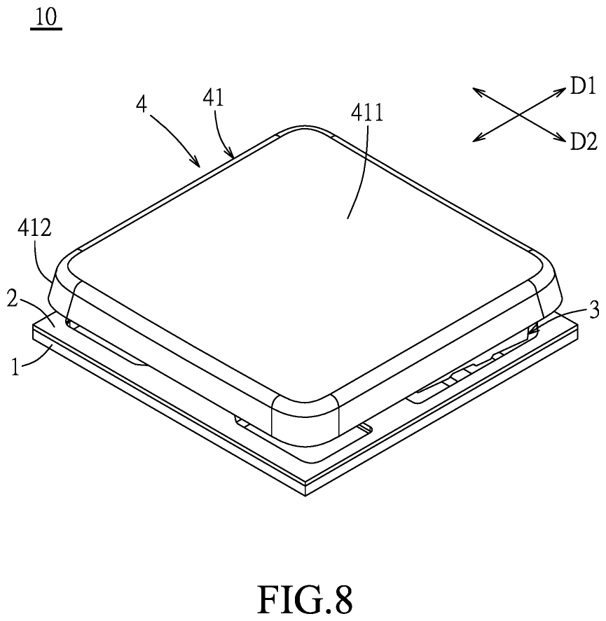

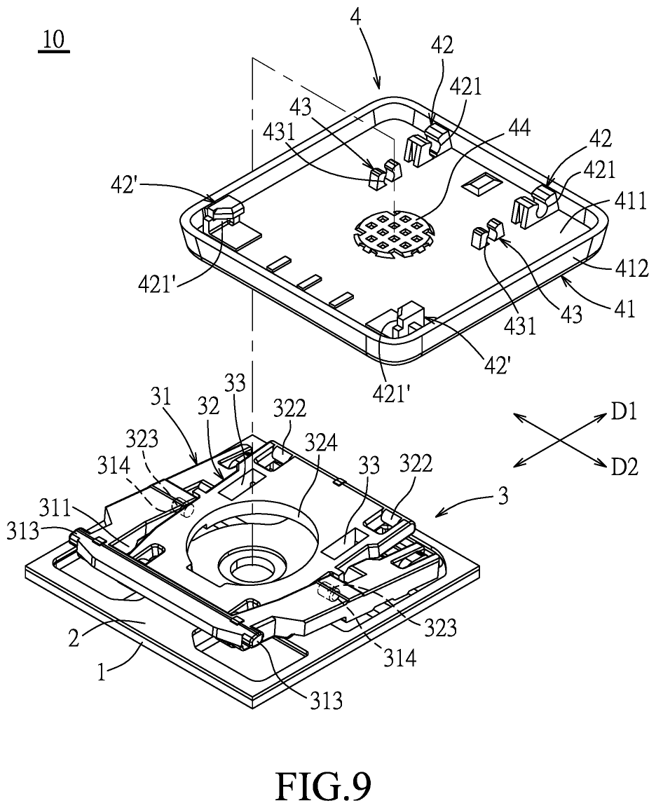

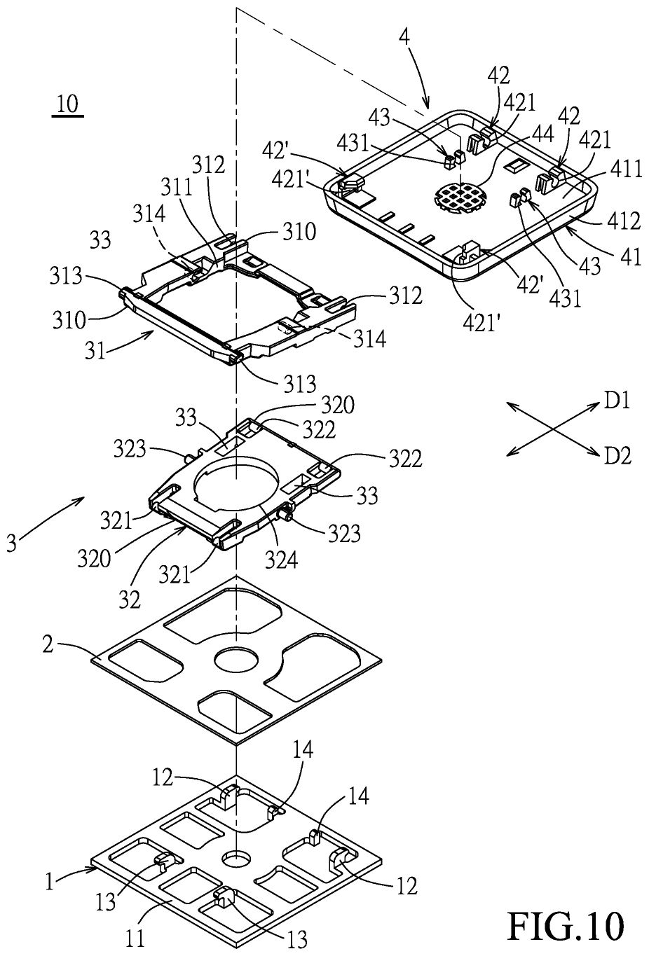

Referring to FIGS. 8 to 10, in a second embodiment, the retaining features 43 are disposed closer to the center of the top wall 411 of the keycap 41 than those of the previous first embodiment, and the recesses 33 are formed in the second supporting member 32.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A keycap of a keyswitch module which includes a supporting mechanism for said keycap to be disposed thereon, said keycap being positioned on a jig for a legend forming process, said keycap comprising:
a keycap body having a top wall and a surrounding wall extending downwardly from a periphery of said top wall;
a plurality of connecting features formed on a lower surface of said top wall of said keycap body and adapted to be retainingly connected with the supporting mechanism; and
at least one retaining feature formed on said lower surface of said top wall and spaced apart from said connecting features, said retaining feature being adapted to be retainingly connected with the jig.

2. The keycap as claimed in claim 1, wherein said retaining feature is distant from a center of said top wall of said keycap body by a distance that is smaller than a distance by which each of said connecting features is distant from said center of said top wall.

3. The keycap as claimed in claim 1, wherein said connecting features are disposed in proximity of said periphery of said top wall.

4. The keycap as claimed in claim 1, wherein said keycap comprises two of said retaining features which are spaced apart from each other and adapted to be retainingly connected with the jig.

5. The keycap as claimed in claim 4, wherein said retaining features are spaced apart from each other in a first direction that is parallel to said lower surface of said top wall of said keycap body, each of said retaining features being distant from a center of said top wall in a second direction that is parallel to said lower surface of said top wall and transverse to the first direction by a distance that is smaller than a distance by which each of said connecting features is distant from said center of said top wail in the second direction.

6. A keyswitch module comprising:
a base plate;
a supporting mechanism movably disposed on said base plate in an up-and-down direction; and
a keycap disposed on and movable with said supporting mechanism, said keycap including a keycap body, a plurality of connecting features and at least one retaining feature, said keycap body having a top wall and a surrounding wall which extends downwardly from a periphery of said top wall, said connecting features being formed on a lower surface of said top wall of said keycap body and being retainingly connected with said supporting-mechanism, said retaining feature being formed on said lower surface of said top wall and being spaced apart from said connecting features, said retaining feature being adapted to be retainingly connected with a jig for a legend forming process.

7. The keyswitch module as claimed in claim 6, wherein said retaining feature is distant from a center of said top wall of said keycap body by a distance that is smaller than a distance by which each of said connecting features is distant from said center of said top wall.

8. The keyswitch module as claimed in claim 6, wherein said connecting features are disposed in proximity of said periphery of said top wall.

9. The keyswitch module as claimed in claim 6, wherein said keycap includes two of said retaining features which are spaced apart from each other and adapted to be retainingly connected with the jig.

10. The keyswitch module as claimed in claim 9, wherein said retaining features are spaced apart from each other in a first direction of said keyswitch module that is parallel to said lower surface of said top wall of said keycap body, each of said retaining features being distant from a center of said top wall in a second direction that is parallel to said lower surface of said top wall and transverse to the first direction by a distance that is smaller than a distance by which each of said connecting features is distant from said center of said top wall in the second direction.

11. The keyswitch module as claimed in claim 6, wherein said retaining feature extends downwardly from said lower surface of said top wall, said supporting mechanism having a mounting wall which faces said lower surface of said top wall, and at least one recess which is formed in said mounting wall for receiving said retaining feature.

11. keyswitch module as claimed in claim 11, wherein said supporting mechanism includes a first supporting member and a second supporting member pivotably connected to each other about a central axis in a first direction, said first supporting member having two first ends which are opposite to each other in a second direction that is transverse to the first direction and which are respectively engaged with one of said connecting features and said base plate, said second supporting member having two second ends which are opposite to each other in the second direction and inboard to said first ends and which are respectively engaged with said base plate and other one of said connecting features so as to connect said supporting mechanism between said base plate and said keycap.

13. The keyswitch module as claimed in claim 12, wherein said keycap includes two of said retaining features which are spaced apart from each other in the first direction and adapted to be retainingly connected with the jig, said retaining features extending downwardly from said lower surface of said top wall, said first supporting member having a mounting wall which faces said lower surface of said top wall, and two recesses which are formed in said mounting wall for receiving said retaining features, respectively.

14. The keyswitch module as claimed in claim 12, wherein said keycap includes two of said retaining features which are spaced apart from each other in the first direction and adapted to be retainingly connected with the jig, said retaining features extending downwardly from said lower surface of said top wall, said second supporting member having a mounting wall which faces said lower surface of said top wall, and two recesses which are formed in said mounting wall for receiving said retaining features, respectively.

15. A jig for positioning a keycap as claimed in claim 1 to perform a legend forming process, comprising:
a jig body; and
a positioning block formed on said jig body, and having a mounting wall which faces and abuts against said lower surface of said top wall of said keycap body, at least one positioning feature which is formed on said mounting wall and engaged with said retaining feature, and a plurality of recesses which are formed in said mounting wall for receiving said connecting features, respectively.

16. The jig as claimed in claim 15, wherein said positioning feature is distant from a center of said mounting wall of said positioning block by a distance that is smaller than a distance by which each of said recesses is distant from said center of said mounting wall.

15. jig as claimed in claim 15, wherein said recesses are formed in proximity of a periphery of said mounting wall of said positioning block.

18. The jig as claimed in claim 15, wherein said positioning block has two of said positioning features which are spaced apart from each other.

19. The jig as claimed in claim 18, wherein said positioning features are spaced apart from each other in a first direction of said jig that is parallel to said lower surface of said top wall of said keycap body, each of said positioning features being distant from a center of said mounting wall in a second direction that is parallel to said lower surface of said top wall and transverse to the first direction by a distance that is smaller than a distance by which each of said recesses is distant from said center of said mounting wall in the second direction.
